(19) United States
(12) Patent Application Publication
(10) Pub. No.: US 2005/0238856 A1
(43) Pub. Date: Oct. 27, 2005

(54) Decorative surface covering structure and method of forming

(76) Inventor: Clement Zanzuri, Miami, FL (US)

Correspondence Address: MALLOY & MALLOY, P.A., Historic Coral Way, 2800 S.W. Third Avenue, Miami, FL, 33129, US

(21) Appl. No.: 11/099,212

(22) Filed: Apr. 5, 2005

Related U.S. Application Data
(63) Continuation-in-part of application No. 10/218,166, filed on Aug. 13, 2002.
Application No. 10/218,166 is a continuation-in-part of application No. 09/777,183, filed on Feb. 5, 2001, now abandoned.

(51) Int. Cl. B32B 31/00

(52) U.S. Cl. 428/196; 156/263; 156/293

(57) ABSTRACT

A decorative surface covering structure and method for the assembly and/or formation thereof, wherein the surface covering structure is specifically, but not exclusively, adaptable for use as a floor covering, wall covering or for the covering of other surfaces as a decorative structure. The structure includes a plurality of interrelated sections disposed in a predefined decorative pattern relative to one another, each of the sections including a rigid material layer and an open mesh backing which provided vertical strength thereto. The rigid material layer of at least two of the sections have a different appearance from one another to achieve the overall decorative appearance, and the open mesh backing on confronting ones of the sections are generally outwardly flared relative to one another so as to define a gap there between that extends into at least some cells of the open celled backing. An adhesive bonding material is disposed in the gap so as to secure the confronting sections with one another and so as to define a backing layer beneath the joint between confronting rigid material layers.

### CLAIM OF PRIORITY

The present application is a continuation-in-part application of previously filed, now pending application having Ser. No. 10/218,166, filed on Aug. 13, 2002 which is a continuation-in-Part application of Ser. No. 09/777,183, filed on Feb. 5, 2001, the contents of which are hereby incorporated by reference.

### BACKGROUND OF THE INVENTION

1. Field of the Invention

This invention is directed to a method of forming a surface covering assembly adaptable for use as a floor covering, wall covering, table or counter top covering, or the like as well, to include a base of stone, tile or similar solid material and which may include one or more inlay sections. Both the base and the inlay sections include an open-mesh, honeycomb type backing disposed thereon to achieve a substantially thin product that can be used with virtually any floor covering, such as tile, and which has a substantial amount of strength and durability despite the inherent fragility of the surface material and the detail or intricacy of the design.

2. Description of the Related Art

In a variety of industries involving the cutting or forming of a solid material it is necessary to perform a very detailed and precise cut in order to form intricate patterns in the solid material being processed. Such cuts are often made by directing a high pressure stream of fluid, such as but not limited too water, which may include abrasive additives, into the surface of the solid material. Naturally, many variables are involved when performing such a high precision fluid cut and accordingly, conventional systems, while at least partially automated, still require a significant amount of monitoring and estimations or judgments to be performed by an individual operator in order to assure that a desired degree of precision and quality in the cut being performed is achieved. In addition, such precision and quality need be maintained throughout the entire cutting process in order to ensure that malfunctions do not occur with the equipment being utilized or the procedure being followed.

It is well known that solid material such as stone, marble, granite, cementious material, tiles, etc. are commonly used as surface coverings and particularly coverings for exposed surfaces for both indoor and outdoor flooring. In that such materials are frequently expensive, many factors need be considered in order to ensure that a desired quality of cut is obtained. More specifically, it is not uncommon utilizing conventional techniques and procedures to encounter a degradation in quality of the cut in a middle portion of the cutting pattern. The result is the ruination of an entire, sometimes elaborate and very expensive item being formed. Depending upon the material being shaped or formed as well as the particular application which such material is intended, an operator may be required to perform any one of a variety of different grades of precision in the cut being performed. Typically, numerous cutting grades are available depending on the intended application of the article being processed. By way of example, an elaborate and decorative inlay system involving relatively intricate perimeter cuts frequently requires a higher degree of cut quality to ensure that inlay sections or mating portions of the product being formed fit together properly. Conversely, many other applications do not necessitate a high quality or precision cut being formed thereby allowing the operator to perform a relatively rough quality of cut. Naturally, it is important to ensure that at least a minimum desired quality is maintained, however, cutting to an excessive quality then is needed does not add any significant or practical benefit.

It is well recognized in the cutting industry of the quality of the cut being performed is directly related to the speed of the cut or the rate at which the highly pressurized stream of fluid and aggregate mixture is directed onto the solid material being shaped. Accordingly, when processing the higher grade, more expensive materials, of the type set forth above, and/or when the product comprises the aforementioned inlaid portions or sections and/or intricate peripheral cuts, a slower cutting process is normally required. The implementation of a faster cutting rate, when forming the products of the type set forth above would result in relatively imprecise cut and further render the mounting and/or positioning of various products, including the inlaid sections, relative to one another difficult or impossible and/or present and unacceptable appearance at the junction of such mated components.

In order to overcome the problems and disadvantages of the type set forth above, the cutting industry has attempted to develop technology, to regulate, monitor and best determine the preferred cutting rate to be utilized for a particular type of material and application. Even with the existence of improved technological advancements, the consistent obtaining of a particular quality cut is difficult and unreliable. Specifically, presently available charts and list only provide general guidelines for the desired rate to be used for a selected cut quality. However, these values are only guidelines that can vary greatly depending on a variety of factors present within the cutting process. For example, the type of cut, the type of material and even the quality of certain portions of a single slab or of different sections of the same material can vary. Such factors commonly alter the quality of the cut that is achieved throughout the entire cutting process. An additional disadvantage associated with present fluid cutting technologies relates to the need for constant monitoring of the system in order to accomplish the degree of quality desired throughout the entire cutting procedure. Such monitoring is at least partially concentrated on maintaining a desired cutting rate in order to accomplish the quality of cut required. The degree of monitoring necessary therefore requires frequent maintenance, repair and replacement of the equipment utilized as well as supervisory personnel being present during the entire cutting or shaping procedure.

Because of the above set forth disadvantages and problems, commonly recognized in the fluid cutting industry, it would be highly beneficial to eliminate the necessity of regulating the speed of a fluid cut or the time and personnel involved in the continuous monitoring of fluid cuts during the entire cutting procedure. Rather than further modify the apparatus utilized in this industry, it would be more beneficial to develop a product, such as, but not limited to, a surface covering assembly which would be adaptable for use as floor coverings, wall coverings, etc. Such an improved surface covering could be highly decorative including one or more inlay sections or components which require peripheral cuts. Further a product of the type described and a method of forming such a product could be processed utilizing a high speed fluid cut procedure. During the fluid cut the precise rate of cut need not be closely monitored or regulated, while still accomplishing a close, precise fit between mating components of the more intricately designed products. In addition, the type of solid material utilized in the formation of such products could vary widely and include various solids now commonly used in floor and other surface coverings, of the type set forth above.

Additionally, it is also recognized in the surface covering industry, that expensive, thicker materials, such as marble or often cost prohibitive to use, and as such, thinner cut materials, including marble or ceramic tile are more commonly used to cover a surface such as a floor. A significant drawback associated with the use of such thinner materials arises when attempting to incorporate a decorative surface covering structure, such as inlayed medallion or the like artistic element. In particular, based upon the nature of the rigid material used to form the decorative surface covering structure, a thicker section of material needed to be used in order to provide for sufficient strength and durability, especially as a floor covering. Unfortunately, such a thicker decorative surface covering structure is not usable when inlayed with thinner floor covering materials such as tile. As such, consumers were required to choose either a thicker material throughout, at greater expense, a fragile, decorative surface covering structure, or no surface covering structure. As such, there is a need in the art for a method of forming a decorative surface covering structure that is able to achieve a thinner configuration, but which has a substantial degree of durability, even as a floor covering. Furthermore, it would be beneficial to provide such a method which can effectively maximize the effective use of a source slab without compromising the integrity of the decorative surface covering through the use of excessively thin material sections that are more susceptible to cracking or other breakage.

### SUMMARY OF THE INVENTION

The present invention relates to a decorative surface covering structure and a method of making a decorative surface covering structure. Specifically, the decorative surface is configured to provide an attractive, ornamental appearance in a variety of uses, including for example, as an inlay medallion used within a floor covering design. The decorative surface covering structure includes at least one base section and at least one inlay section disposed in an interrelated relation with one another so as to define, at least partially, an attractive appearance of the decorative surface covering structure. For example, in one preferred embodiment the base section and inlay section may be formed of different colored or different patterned materials at an exposed face thereof such that by inlaying or interrelating the various sections relative to one another an attractive design can be achieved. In this regard, it is recognized that a plurality of base sections and/or a plurality of inlay sections may be provided as dictated by a desired design.

Specifically, the base section(s) and inlay section(s) preferably include a first layer formed of a generally rigid decorative material, such as stone, marble, granite and/or any other attractive natural or man made material. Moreover, disposed on an undersurface thereof is an open mesh backing. Specifically, the open mesh backing preferably includes an open celled or honeycomb type configuration that provides a substantial amount of reinforcement to the rigid material layer disposed thereon. As a result, the rigid material layer and indeed the overall base and inlay sections can be substantially thin while still maintaining a substantial degree of strength and/or stability, even if the decorative surface covering forms part of a floor covering and will be walked upon extensively.

In order to maintain the structural and attractive integrity of the overall decorative surface covering, the one or more inlay sections and one or more base sections are preferably inlayed and secured with one another by an adhesive. In particular, an adhesive bonding material, such as a liquid epoxy, is disposed between confronting portions of the various sections. Further, in addition to bonding the confronting faces of the rigid material layers to one another, the adhesive bonding material also preferably extends down into the open mesh backing, essentially filling the open cells thereof that are in fluid communication with the joint between the confronting surfaces. As a result, when the adhesive bonding material hardens, it defines a wide, hardened base area within the open cells beneath the joint, providing a substantially increased degree of rigidity and durability at the joints between confronting material sections and providing increased bonding as the hardened material cannot readily be removed from partially open cells. For example, where the decorative surface covering structure is used in a floor covering embodiment, a pressure at or near the joint, such as by a pointed heel, will generally not result in damage and/or chipping at the joint region as the open mesh backing as well as the hardened adhesive bonding material serve to provide a backing reinforcement that eliminates flexing of the rigid material layer.

In addition to the decorative surface covering structure, the present invention is further directed toward a method of forming and assembling a decorative surface covering structure in an efficient, durable, cost effective, and consistent manner that defines an attractive and functional surface. Specifically, the method includes an initial step of applying a first open mesh backing to an undersurface of a base material to define a base slab, and applying a second open mesh backing to an undersurface of an inlay material to define an inlay slab. Next, the individual slabs, namely at least the base slab and the inlay slab are shaped, preferably such that they each will have a maximum thickness. Once shaped to that maximum thickness, undersized and satisfactorily sized portions of the individual slabs are identified, satisfactorily sized portions having generally the maximum thickness to which the slabs were shaped.

With the satisfactorily sized portions of the base and inlay slabs effectively identified, one or more base sections and inlay sections are defined in the satisfactorily sized portions of the corresponding slabs, and are thereafter cut utilizing a precision cutting technique. The individual base sections and inlay sections are then disposed on a support surface in generally interrelated relation with one another so as to define a predetermined decorative configuration. Finally, the base sections and the inlay sections are bonded with one another so as to define the decorative surface covering structure. Additionally, preferably during this bonding procedure, an adhesive material is preferably disposed around a perimeter of the interrelated base and inlay sections so as to effectively form a perimeter seal between the base and inlay sections and the support surface upon which they have been disposed. Thereafter, a fluid adhesive bonding material is preferably directed into the joints and/or confronting surfaces between the interrelated base and inlay sections, the adhesive bonding material being urged down inward beyond the rigid material layer of the base and inlay sections and into the open mesh backing material so as to fill open cell spaces beneath the joint and effectively provide for securement of the various sections to one another as well as an added reinforcement at the specific joints.

### BRIEF DESCRIPTION OF THE DRAWINGS

For a fuller understanding of the nature of the present invention, reference should be had to the following detailed description taken in connection with the accompanying drawings in which:

FIG. 1 is a top view of an example of a decorative surface covering structure of the present invention;

FIG. 2 is a cross sectional view illustrating interrelated positioning of a base section and inlay section on a support surface;

FIG. 3 is a bottom view of an embodiment of the open mesh backing material;

FIG. 4 is a perspective illustration of a slab which can be utilized to define the base or inlay slabs;

FIG. 5 is a perspective illustration of a slab with the undersized and satisfactorily sized portions identified thereon such that appropriate base or inlay sections may be cut from the satisfactorily sized portions thereof;

FIG. 6 is an isolated view of a joint between confronting slab sections illustrating the placement of the adhesive bonding material for securement and reinforcement purposes at and beneath a joint there between; and

FIG. 7 is an illustration of one method of achieving an effective and secure seal between the open mesh backing and a material layer.

Like reference numerals refer to like parts throughout the several views of the drawings.

### DETAILED DESCRIPTION OF THE PREFERRED EMBODIMENT

Shown throughout the figures, the present invention is directed towards a decorative surface covering structure, generally indicated as 10 and further toward a method of forming and assembling the decorative surface covering structure 10. Specifically, the decorative surface covering structure 10 is configured to define a variety of attractive uses such as in connection with a table top, counter top, and/or more commonly as an inlay portion of a floor covering whereby the attractive and decorative appearance of the decorative surface covering structure can significantly enhance the overall appearance of a medium in connection with which it is utilized. Along these lines, the decorative surface covering structure may define an entire exterior finished surface and/or may merely provide an inlay, such as a medallion inlay in a floor covering design disposed on an underlying surface.

Looking first to the preferred method of forming and assembling the decorative surface covering structure 10, it may preferably include an initial step of defining one or more slabs 15 of a desired material appearance. In particular, the slab 15 may define a base or inlay slab, as will be described subsequently. Further, although a number of different slabs 15 may ultimately be provided in order to provide a plurality of base slabs and/or a plurality of inlay slabs as dictated specifically by the design needs of a specific decorative surface covering structure 10, it is preferred that at least one base slab and one inlay slab having different exterior appearances from one another be provided to achieve a desired ornamental appearance of the decorative surface covering structure 10. For example, for purposes of clarity, a base slab and an inlay slab are defined, however, it is understood that typically these slabs will differ from one another only with regard to their appearance, but can often be used interchangeably, the base slab more commonly being used to define a first, more dominant and/or exterior appearance of the finished product.

In order to define each slab, an open mesh backing 40 is preferably applied to an undersurface of a rigid material layer 16. In particular, the rigid material layer 16 may be formed from any of a variety of generally rigid materials such as stone, marble, granite and/or any other man made or naturally obtained generally rigid material that has at least one surface thereof, namely a top surface, which can ultimately achieve an attractive appearance and can be integrated into a design of the decorative surface covering structure 10. In the illustrated embodiment wherein a base slab and an inlay slab are provided, a first open mesh backing 40 is applied to an undersurface of a base material to define the base slab and a second open mesh backing is applied to an undersurface of an inlay material to define the inlay slab. As for the open mesh backing, it preferably is a generally rigid, at least in a vertical plane so as to provide a substantial degree of strength and reinforcement along that vertical plane. As such, a generally honeycomb type of open cell material may be provided and can be formed of any of a variety of materials including a metal, plastic or other material that provides strength and reinforcement at least in a vertical plane atop which the rigid material 16 is disposed. Accordingly, when a force or weight is disposed on a top surface of the rigid material 16, the open mesh backing 40 will provide for effective reinforcement and spacing to an overall surface of the rigid material panel 16 above an underlying surface, such as a foundation floor upon which a floor covering is to be disposed. Also, in order to achieve a preferred reinforcement, it may be preferable, although not necessary in all instances for the open mesh backing 40 to be at least as thick as the rigid material panel 16 which it supports. In this manner, a substantial degree of strength and rigidity can be provided to a relatively thin rigid material panel 16 and an overall thickness of the slab can be substantially small corresponding to the thickness of conventional tile floor covering in most instances. For example, it is recognized that conventional surface covering and/or flooring materials are typically made relatively thin so as to reduce cost and so as to provide a generally uniform surface. As such, the present invention allows for a decorative surface covering structure 10 to be utilized with these thinner types of floor coverings without compromising the integrity of the material to be utilized to define the decorative surface covering structure even when substantially intricate patterns are ultimately defined. In particular, many attractive materials that would be used for such a structure are very fragile, and if made the thickness of a standard floor tile, they would be susceptible to cracking and breakage.

Although it is recognized that a slab 15 can be formed one at a time by securing a thin rigid material layer 16 to the open mesh backing 40, in a preferred, illustrated embodiment two slabs 15 are often defined one time so as to provide for better bonding between the open mesh backing 40 and the rigid material panel 16, and so as to maximize the utilization of the raw material panel 18 which often has a thickness greater than the desired thickness of the rigid material layer 16 due to the need to maintain its structural integrity and minimize its susceptibility to breakage or cracking. In particular, as mentioned, when the raw material 18 is generally cut into thinner rigid material layers 16 as utilized in the present invention, those thinner rigid material layers 16 are usually unstable and susceptible to cracking and/or other breakage, thereby further suggesting the novelty of a present surface covering structure 10 and method of forming same. In the embodiment of FIG. 7, an open mesh backing 40 is secured via an adhesive bonding material to each of the opposite faces of the raw material panel 18. Moreover, this combined structure is preferably contained within a flexible vacuum container 66 which is subjected to a vacuum 65 in order to substantially press the open mesh backings 40 against the raw material panel 18 to promote bonding and fastening thereto. Also, if desired, although not shown for purposes of clarity, a further material layer such as a fiberglass layer may be disposed over the open mesh backing 40 so as to essentially cover the open cells 45 during manufacture and use. Once the raw material panel 18 is removed from the vacuum container 66 with the open mesh backings 40 effectively secured to opposite sides thereof, it is preferably cut generally in half utilizing any of a variety of conventional cutting equipment. Given the nature of the rigid material that is ultimately to be utilized in the preferred embodiment to define the raw material panel 18, a wire saw may be the preferred mode of cutting the raw material 18. In this fashion, two slabs 15 are ultimately formed. Also, it is recognized that these two slabs 15 that are formed, as they will have generally the same surface appearance as one another may both be utilized to define base slabs or inlay slabs as dictated by the design consideration of the decorative surface covering structure 10 to be produced.

With the individual slabs 15 formed, namely at least one base slab and at least one inlay slab, the slabs are next shaped to have a maximum thickness. Prior to the shaping process, however, a quantity of paint 50 or other marking material is disposed on a top surface of the rigid material layer 16. Thereafter, each individual slab 15 is shaped, such as by grinding, polishing or cutting to a desired maximum and uniform thickness. In a preferred embodiment, this maximum uniform thickness may be in the range of 0.4 inches. With each slab 15 shaped to that maximum thickness, undersized and satisfactorily sized portions of the individual slabs 15 are then identified. For example, as illustrated in FIG. 5, after the individual slab 15 has been shaped to the maximum thickness, some paint 50 may remain on portions of the rigid material panel 16. The presence of the paint 50 serves as an indicator that those portions of the slab are undersized, as they were not impacted by the shaping process which essentially reduced the size of the overall slab 15 to the maximum thickness. Although in some instances, the undersized portions of the slab 15 may still be usable, it is recognized that to achieve maximum quality control and product uniformity, especially if a finished decorative surface covering structure 10 is to be utilized as a part of a floor covering and will be subjected to constant pressures, it is preferred that those undersized portions of the slab 15 not be utilized as the rigid material layer at those undersized portions may be unsatisfactorily thin and may be more susceptible to breakage, cracking and/or puncture.

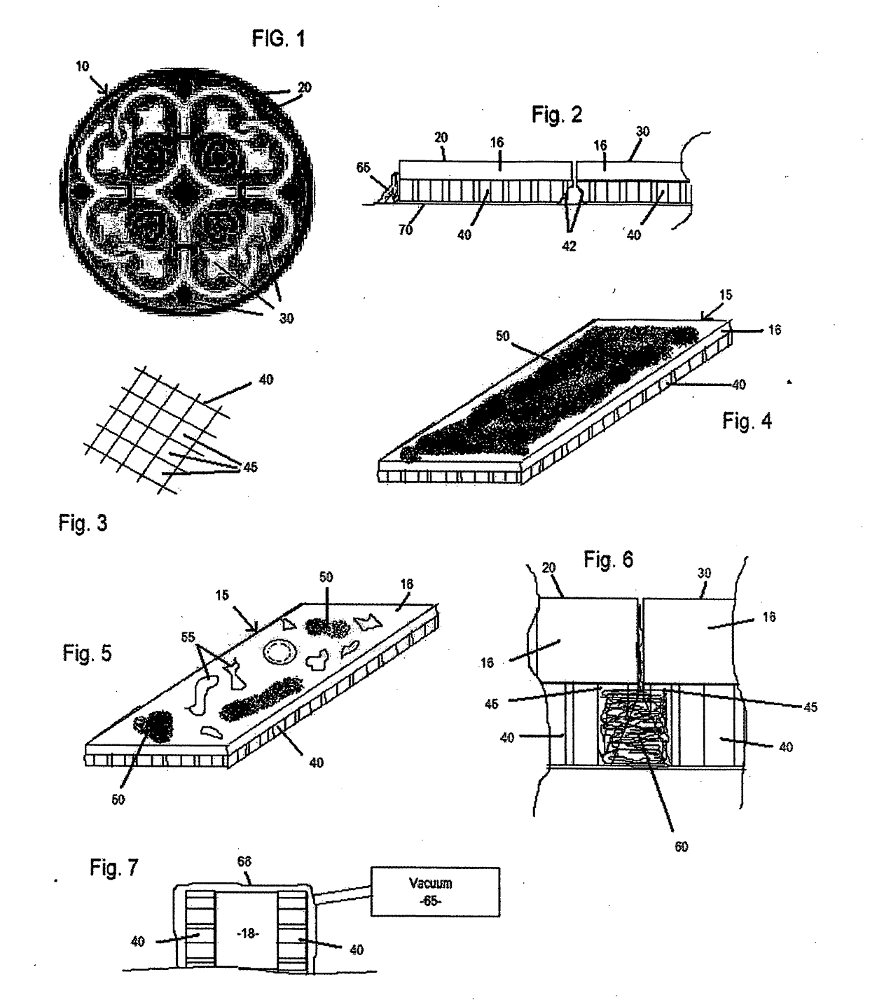

With the satisfactorily sized portions of the individual slabs 15 effectively identified, desired decorative sections to be produced utilizing that particular slab 15 are identified on the slab 15, as at 55. In this regard, it is recognized that the sections 55 may be physically drawn and/or demarcated on the slab 15 and/or may merely be identified in connection with the cutting process, such as using computerized mapping. In particular, with the sections to be cut effectively identified on the slab 15, at least one base section 20 is cut from the base slab and at least one inlay section 30 is cut from the inlay slab. This cutting is preferably achieved utilizing a high precision water jet cutting technique which passes through the entire slab 15 effectively cutting desired artistic patterns therefrom. Moreover, it is recognized that so as to conserve the maximum use of the material of the slabs 15, use of the satisfactorily sized portions of the slab 15 is preferably maximized by cutting as many sections as possible from each individual slab 15. In this regard, it is recognized that an individual slab 15 may be utilized for the formation of multiple decorative surface covering structures 10 depending on the size and number of sections which are to be cut from each individual slab 15. Furthermore, as previously mentioned a plurality of base slabs and/or a plurality of inlay slabs may ultimately be provided, the base slab being identified as such only for purposes of clarity in connection with a primary or one of the primary material appearances of the decorative surface covering structure 10, and/or in some embodiments as a slab from which a base section having an open interior region, as illustrated in FIG. 1, may be cut and into which inlay sections and/or other base sections are inserted, may be provided. As such, in connection with the illustrated embodiment of FIG. 1, one material may be utilized to define one base slab and a plurality of base sections 20 whereas one or more inlay slabs may ultimately be provided so as to define a plurality of inlay sections 30, each inlay section possibility including a different appearance or being of a different color so as to achieve the desired pattern. Moreover, it is recognized that the intricacy and detail of the ultimate decorative appearance of the decorative surface covering structure 10 is virtually infinite based upon the creativity of the designers and the availability of different appearing materials for the formation of the slabs 15.

With the one or more base sections and one or more inlay sections effectively cut, a support surface 70 is preferably prepared for assembly of the decorative surface covering structure 20. In particular, the base sections 20 are preferably disposed on the support surface 70 with the inlay sections 30 disposed in generally interrelated relation with one another and with the base section(s) 20, thereby achieving a desired pattern.

Also, it is preferred that the support surface 70 be constructed of a generally non-bonding material so that adhesive may stick to it, but not ultimately bond so as to prevent detachment of an article disposed thereon. In this regard, it may be preferred that the support surface 70 have a quantity of adhesive material disposed thereon onto which the base sections 20 and inlay sections 30 are disposed. In particular, this adhesive material disposed on the support surface 70 effectively secures the respective sections 20 and 30 to the support surface 70 during finishing of the decorative surface covering structure 10, preventing inadvertent movement of the sections 20 and 30, and in some instances, preventing floating thereof when a further liquid adhesive bonding material is introduced, as will be described. Although a variety of different materials may ultimately be utilized, an epoxy material may be preferred to be disposed on the support surface 70, the non-bonding characteristic of the support surface 70 effectively providing for detachment of the base and inlay sections therefrom in a desired manner.

In addition to disposing the adhesive material on the support surface 70, it may also be preferred to dispose an adhesive material 65 around an exterior perimeter of the interrelated sections disposed on the support surface 70. In particular, this disposing of the adhesive 65 around the perimeter will effectively prevent any fluid seepage from beneath the base and inlay sections 20 and 30 in a subsequent step to be described.

Specifically, once the one or more base sections 20 and inlay sections 30 are effectively disposed in their interrelated relation with one another so as to define the attractive appearance for the decorative surface covering structure 10 atop the support surface 70, the individual sections are thereafter bonded with one another so as to define a single decorative surface covering structure 10. In order to achieve this effective bonding, a quantity of liquid adhesive bonding materials is preferably disposed in all of the joints between the confronting base and inlay sections, as best seen in FIGS. 2 and 6. Specifically, the liquid adhesive bonding material 60 is preferably provided in a very fluid form so as to easily flow down the very narrow gap and/or joint between the confronting rigid material layers 16 of the base and inlay sections 20 and 30. Additionally, it is also recognized that during effective cutting of the base and the inlay sections preferably utilizing the fluid jet cutting techniques, the cutting movement of the fluid stream effectively produces a trailing or flaring of the stream such that there is a flaring and/or enlargement of the spacing of the joint as at 42 between confronting sections of the open mesh backing 40. This increased gap or opening defined by the flared out portions 42 of the open mesh backing 40 generally provides a large space into which the adhesive bonding material 60 can be introduced. Moreover, the chambers and/or cells 45 of the open mesh backing 40 that are opened by the cutting and are in communication with that joint between the confronting base and inlay sections 20 and 30 are also essentially filled with the adhesive bonding material 60. Accordingly, a larger volume of the adhesive bonding material 60 is defined between the confronting portions of open mesh backing 40, including within the chambers 45 at that region, which is much larger than the often very small joint between the confronting rigid material layers. As a result, once the adhesive bonding material 60 effectively hardens a very strong and secure reinforcement is provided at the joint, which is even greater than what can be achieved utilizing only the open mesh backing 40, and increased bonding of adjacent sections is achieved as the hardened adhesive bonding material cannot be readily pulled from many of the open cells it has filled, thus providing a mechanical as well as an adhesive bond. Furthermore, if a direct pressure is applied at or near that joint between the confronting sections, such as due to a person walking over the decorative surface covering structure 10 with pointed heels, those edges and/or confronting joints will not be susceptible to chipping and/or breakage as may otherwise be the case.

Once the respective base and inlay sections 20 and 30 are effectively bonded to one another so as to define the attractive overall appearance of the decorative surface covering structure 10, the decorative surface covering structure 10 is preferably removed from the support surface 70. In particular, based upon the non-bonding characteristics of the support surface 70, generally facilitated removal there from can be achieved. Finally, for final finishing of the decorative surface covering structure 10, it may be desired for a perimeter of the decorative surface covering structure 10 to be trimmed, such as by grinding or cutting, thereby effectively providing a smooth and uniform perimeter dimension and appearance and removing any remaining adhesive 65. Also, at least a top surface of the decorative surface covering structure 10 is preferably further shaped, such as by grinding and/or polishing so as to smooth out any imperfections and/or unevenness that may still result in the top surface of the decorative surface covering structure 10, and to provide an attractive finish. Finally, the polished decorative surface covering structure 10 is provided for appropriate installation as needed and so as to provide substantial attractive enhancement.

From the preceding, it can also be seen that the present invention is directed towards a decorative surface covering structure 10. In particular, the decorative surface covering structure 10 preferably includes at least one base section 20 and at least one inlay section 30, although as previously recited a plurality of inlay sections 30 and/or a plurality of base sections 20 may be provided, each of a common or differing appearances from one another as dictated by design considerations. Specifically, the base and inlay sections 20 and 30 each preferably include a rigid material layer 16 defining a top surface thereof and defining the attractive visible side of the decorative surface covering structure 10. Disposed on an undersurface of that rigid material panel 16 is an open mesh backing 45. The open mesh backing 45 is preferably of an open celled construction and can be formed of a variety of materials that have a generally rigid vertical strength. This open mesh backing 40 is preferably at least the thickness of the rigid material panel 16 that defines each of the individual sections 20 or 30 and effectively provides a substantial degree of strength, rigidity and resistance to cracking or other breakage of the decorative surface covering structure 10 that is defined by the interrelated base and inlay sections 20 and 30. Further, a quantity of an adhesive bonding material 60 is preferably disposed within the joints defined between confronting sections that make up the overall attractive design of the decorative surface covering structure 10. Specifically, this adhesive bonding material 60 is preferably disposed at the joint between the confronting rigid material layers 16, as well as within an area between confronting portions of the open mesh backing 40, including within exposed chambers and/or cells 45 of the open mesh backing so as to provide a hardened secured component that not only fastens the sections to one another, both through the adhesive bonding and by filling the individual chambers which essentially enclose and/or partially contain the hardened adhesive bonding material 60 and provide a mechanical bond against separation between adjacent sections, as well as to provide a substantial degree of backing reinforcement at the joint between sections to further resist cracking and/or breakage at those joints.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. A method of forming and assembling a decorative surface covering structure, said method comprising:
a) applying a first open-mesh backing to an undersurface of a base to define a base slab, and a second open-mesh backing to an under surface of an inlay section to define an inlay slab;
b) shaping said base slab to have a maximum thickness;
c) shaping said inlay slab to have a maximum thickness;
d) identifying undersized and satisfactorily sized portions of said base slab and said inlay slab;
e) cutting at least one base section from said satisfactorily sized portions of said base slab, and at least one inlay section from satisfactorily sized portions of said inlay slab,
f) disposing said base section and said inlay section on a support surface in generally interrelated relation with one another so as to define a predetermined decorative configuration, and p1 g) bonding said base section to said inlay section to define the decorative surface covering structure.

2. The method of claim 1 further comprising applying a quantity of an adhesive material to said support surface, said support surface being non-bonding.

3. The method of claim 2 further comprising disposing said base section and said inlay section on said adhesive material on said support surface, open-meshed backing side down so as to prevent fluid seepage between said base and inlay sections and said support surface during bonding.

4. The method of claim 2 further comprising further comprising applying a quantity of said adhesive around a perimeter of said base section and inlay section disposed on said support surface in inter-related relation with one another so as to prevent fluid seepage from beneath said base section and said inlay section at said perimeter.

5. The method of claim 4 further comprising trimming said perimeter to define a perimeter of the decorative surface covering.

6. The method of claim 1 further comprising applying a quantity of paint to said base slab and said inlay slab prior to shaping to said maximum thickness, portions of said base slab or said inlay slab having substantial quantities of paint remaining thereon subsequent to shaping being said undersized portions.

7. The method of claim 1 further comprising cutting a plurality of inlay sections from said satisfactorily sized portions of said inlay slab.

8. The method of claim 1 further comprising cutting a plurality of base sections from said satisfactorily sized portions of said base slab.

9. The method of claim 1 further comprising cutting said base section to include an open interior region, and disposing a plurality of said inlay sections in said open interior region.

10. The method of claim 1 further comprising defining a plurality of different inlay slabs, at least one of said inlay sections being defined from each of said inlay slabs.

11. The method of claim 1 wherein said step of applying said first and said second open-mesh backing comprises applying a generally rigid honeycomb backing.

12. A method of forming and assembling a decorative surface covering structure, said method comprising:
a) applying a first open-mesh backing to an undersurface of a base to define a base slab, and a second open-mesh backing to an under surface of an inlay section to define an inlay slab;
b) cutting at least one base section from said base slab, and at least one inlay section from said inlay slab;
c) applying a quantity of an adhesive material to a non-bonding support surface;
d) disposing said base section and said inlay section in generally interrelated relation with one another, open mesh backing side down, on said adhesive material on said support surface so as to define a generally fluid impervious seal between said base and said inlay sections and said support surface and so as to define a predetermined decorative configuration;
e) introducing a quantity of a liquid adhesive bonding material between adjacent edges of said inlay section and said base section so as to generally fill a gap therebetween, including adjacent chambers of said open mesh backing, so as to bond said base section with said inlay section to define the decorative surface covering structure and to re-enforce said gap with hardened quantities of said liquid adhesive.

13. The method of claim 12 further comprising applying a quantity of said adhesive around a perimeter of said base section and inlay section disposed on said support surface in inter-related relation with one another so as to prevent fluid seepage from beneath said base section and said inlay section at said perimeter.

14. The method of claim 13 further comprising trimming said perimeter to define a perimeter of the decorative surface covering.

15. The method of claim 12 further comprising shaping said base and said inlay slabs so as to identify satisfactorily sized portions of said slabs.

16. The method of claim 15 further comprising cutting a plurality of inlay sections from said satisfactorily sized portions of said inlay slab.

17. The method of claim 15 further comprising cutting a plurality of base sections from said satisfactorily sized portions of said base slab.

18. The method of claim 12 further comprising cutting said base section to include an open interior region, and disposing a plurality of said inlay sections in said open interior region.

19. The method of claim 12 further comprising defining a plurality of different inlay slabs, at least one of said inlay sections being defined from each of said inlay slabs.

20. The method of claim 12 wherein said step of applying said first and said second open-mesh backing comprises applying a generally rigid honeycomb backing.

21. A decorative surface covering structure comprising:
a) a plurality of interrelated sections disposed in a predefined pattern relative to one another;
b) each of said sections including a rigid material layer and an open mesh backing, said rigid material layer of at least two of said sections having a different appearance from one another;
c) said open mesh backing on confronting ones of said sections being generally outwardly flared relative to one another so as to define a gap therebetween;
d) said gap extending into at least some cells of said open celled backing; and
e) an adhesive bonding material disposed in said gap so as to secure said confronting sections with one another and so as to define a backing layer beneath the joint between confronting rigid material layers.

22. A decorative surface covering structure a recited in claim 21 wherein said open mesh backing is vertically rigid.

23. A decorative surface covering structure as recited in claim 21 wherein said open mesh backing is at least as thick as said rigid material layer.
